(19) United States
(12) Patent Application Publication
(10) Pub. No.: US 2026/0155461 A1
(43) Pub. Date: Jun. 4, 2026

(54) LITHIUM SECONDARY BATTERY, AND METHOD FOR PRODUCING LITHIUM SECONDARY BATTERY

(71) Applicants: TOYOTA JIDOSHA KABUSHIKI KAISHA, Aichi-ken (JP); TOHOKU UNIVERSITY, Miyagi (JP)

(72) Inventors: Daisuke HORIKAWA, Toyota-shi, Aichi-ken (JP); Hiroyuki YAMAGUCHI, Toyota-shi, Aichi-ken (JP); Hiroshi TSUBOUCHI, Nagoya-shi, Aichi-ken (JP); Tetsu ICHITSUBO, Sendai-shi, Miyagi-ken (JP); Hongyi LI, Sendai-shi, Miyagi-ken (JP)

(21) Appl. No.: 18/970,908

(22) Filed: Dec. 6, 2024

(30) Foreign Application Priority Data
Dec. 15, 2023 (JP) 2023-212111

(51) Int. Cl. H01M 10/42; H01M 4/02; H01M 4/134; H01M 4/1395; H01M 4/40

(52) U.S. Cl. CPC H01M 10/4235; H01M 4/134; H01M 4/1395; H01M 4/405; H01M 2004/021; H01M 2004/027

(57) ABSTRACT

An object of the present disclosure is then to provide a lithium secondary battery with a lithium metal and/or a lithium alloy as a negative electrode active material, in which the lithium secondary battery can be enhanced in capacity retention rate and reduced in resistance value. A lithium secondary battery, wherein the lithium secondary battery comprises a negative electrode current collector layer, a negative electrode active material layer, an inorganic porous layer, an electrolyte layer, a positive electrode active material layer, and a positive electrode current collector layer in the listed order, the negative electrode active material layer contains a lithium metal or a lithium alloy, and the inorganic porous layer contains a metal compound containing at least one metal element selected from calcium, barium, lanthanum, and cerium.

### FIELD

The present disclosure relates to a lithium secondary battery, and a method for producing a lithium secondary battery.

### BACKGROUND

Lithium secondary batteries with lithium metals and/or lithium alloys as negative electrode active materials are large in potential difference between negative electrodes and positive electrodes to achieve a high output voltage, and have a high theoretical capacity density and thus can be expected to be put into practical use, and the following lithium secondary battery is disclosed.

For example, PTL 1 discloses a lithium secondary battery utilizing a deposition-dissolution reaction of a lithium metal, as the reaction of a negative electrode, in which the negative electrode comprises a negative electrode layer, the negative electrode layer contains an alloy of the lithium metal and a dissimilar metal, as a negative electrode active material, and the element ratio of a lithium element in the alloy in full charge of the lithium secondary battery is 40.00 atomic % or more and 99.97 atomic % or less. According to PTL 1, there can be provided a lithium secondary battery which can be enhanced in capacity retention rate.

### CITATION LIST

### Patent Literature

PTL 1: Japanese Unexamined Patent Publication (Kokai) No. 2023-103517

### SUMMARY

### Technical Problem

Lithium secondary batteries with lithium metals and/or lithium alloys as negative electrode active materials, while are expected to have excellent battery characteristics, are actually low in capacity retention rate and also high in resistance value, and such characteristics are still not sufficient. Therefore, such lithium secondary batteries have room for improvement in terms of capacity retention rate and resistance value.

An object of the present disclosure is then to provide a lithium secondary battery with a lithium metal and/or a lithium alloy as a negative electrode active material, in which the lithium secondary battery can be enhanced in capacity retention rate and reduced in resistance value.

### Solution to Problem

The present disclosure is to achieve the above object by the following measures.

### <Aspect 1>

A lithium secondary battery, wherein
the lithium secondary battery comprises a negative electrode current collector layer, a negative electrode active material layer, an inorganic porous layer, an electrolyte layer, a positive electrode active material layer, and a positive electrode current collector layer in the listed order,
the negative electrode active material layer contains a lithium metal or a lithium alloy, and
the inorganic porous layer contains a metal compound containing at least one metal element selected from calcium, barium, lanthanum, and cerium.

### <Aspect 2>

The lithium secondary battery according to Aspect 1, wherein the thickness of the inorganic porous layer is 10 nm to 100 μm.

### <Aspect 3>

The lithium secondary battery according to Aspect 1 or 2, wherein the metal compound is selected from the group consisting of metal oxide, metal phosphate, metal sulfide, metal carbonate, metal alkoxide, metal hydroxide, and any combination thereof.

### <Aspect 4>

A method for producing the lithium secondary battery according to any one of Aspects 1 to 3, the method comprising impregnating the negative electrode current collector layer with a solution containing the metal element and lithium, to form the negative electrode active material layer and the inorganic porous layer on a surface of the negative electrode current collector layer by an electrolytic reaction.

### Advantageous Effects of Invention

According to the present disclosure, it is possible to allow a lithium secondary battery with a lithium metal and/or a lithium alloy as a negative electrode active material to be enhanced in capacity retention rate and reduced in resistance value.

### BRIEF DESCRIPTION OF DRAWINGS

FIG. 1 is a schematic view for describing the lithium secondary battery of the present disclosure.

FIG. 2A is a schematic view for describing the method for producing the lithium secondary battery of the present disclosure.

FIG. 2B is a schematic view for describing the method for producing the lithium secondary battery of the present disclosure.

FIG. 2C is a schematic view for describing the method for producing the lithium secondary battery of the present disclosure.

### DESCRIPTION OF EMBODIMENTS

Hereinafter, embodiments of the present disclosure are described in detail. Herein, the present disclosure is not limited to the following embodiments, and can be variously modified and carried out within the gist of the present disclosure. In the description of the drawings, the same symbol is applied to the same element, and the overlapped description is omitted.

In the present disclosure, the “mixture” means a composition which can directly form or further contain any other component to form a positive electrode active material layer or the like. In the present disclosure, the “mixture slurry” means a slurry which contains, in addition to the “mixture”, a dispersion medium and thus can be applied and dried to form a positive electrode active material layer or the like.

The lithium secondary battery of the present disclosure may be a liquid-based battery containing an electrolytic solution as an electrolyte layer, or may be a solid-state battery comprising a solid electrolyte layer as an electrolyte layer. In the present disclosure, the “solid-state battery” means a battery with at least a solid electrolyte as an electrolyte, and therefore a combination of a solid electrolyte and a liquid electrolyte may be used as an electrolyte in the solid-state battery. The lithium secondary battery of the present disclosure may be an all-solid-state battery, namely, a battery with only a solid electrolyte as an electrolyte.

### <<Lithium Secondary Battery>>

The lithium secondary battery of the present disclosure comprises
a negative electrode current collector layer, a negative electrode active material layer, an inorganic porous layer, an electrolyte layer, a positive electrode active material layer, and a positive electrode current collector layer in the listed order,
the negative electrode active material layer contains a lithium metal or a lithium alloy, and
the inorganic porous layer contains a metal compound containing at least one metal element selected from calcium, barium, lanthanum, and cerium.

According to the present disclosure, it is possible to allow a lithium secondary battery with a lithium metal and/or a lithium alloy as a negative electrode active material to be enhanced in capacity retention rate and reduced in resistance value.

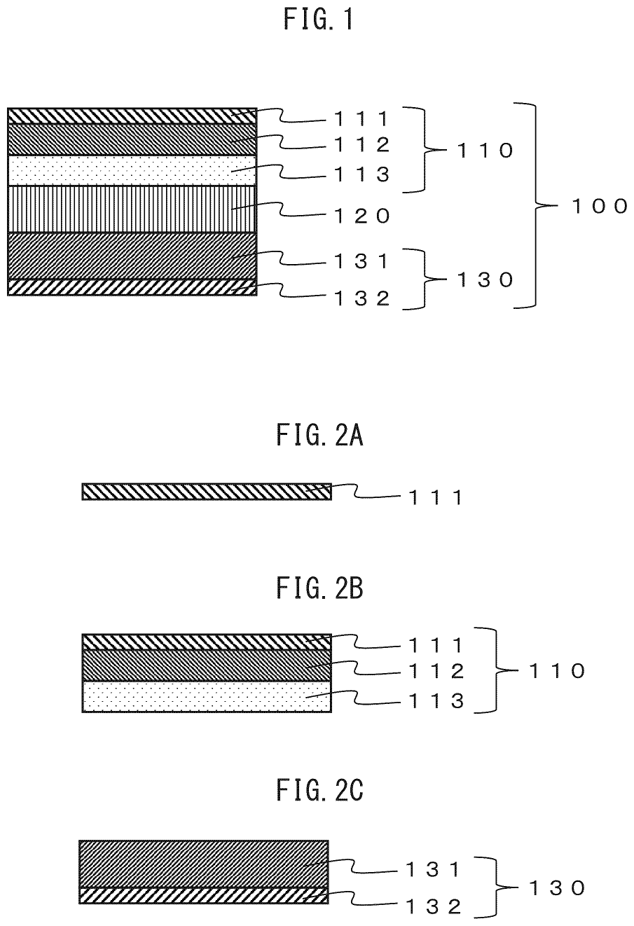

The lithium secondary battery of the present disclosure comprises a negative electrode current collector layer 111, a negative electrode active material layer 112, an inorganic porous layer 113, an electrolyte layer 120, a positive electrode active material layer 131, and a positive electrode current collector layer 132 in the listed order, specifically, for example, as illustrated in FIG. 1, and the inorganic porous layer 113 contains at least one metal element selected from calcium, barium, lanthanum, and cerium.

Without being limited by theory, the inorganic porous layer is a porous layer formed from an inorganic substance and therefore is presumed to be high in mechanical strength and electronic insulating properties and to be able to suppress decomposition of an electrolytic solution and breakage of a solid-electrolyte interface (Solid Electrolyte Interphase; SEI),
resulting in an enhancement in capacity retention rate. An oxide of a metal element such as lanthanum is also known as an oxide solid electrolyte and is presumed to be high in lithium conductivity and to increase the lithium carrier concentration at an interface between the inorganic porous layer and the negative electrode active material layer, resulting in a reduction in battery resistance. Furthermore, it is presumed that a porous shape is adopted, thereby allowing the electrolytic solution to be promoted in diffusion into the inorganic porous layer and to easily reach the negative electrode active material, resulting in a reduction in battery resistance.

### <Configuration of Lithium Secondary Battery>

The lithium secondary battery of the present disclosure comprises a negative electrode current collector layer, a negative electrode active material layer, an inorganic porous layer, an electrolyte layer, a positive electrode active material layer, and a positive electrode current collector layer in the listed order.

### <Negative Electrode Current Collector Layer>

The material used in the negative electrode current collector layer is not particularly limited, and a common negative electrode current collector for lithium secondary batteries can be appropriately selected. Examples of the material used in the negative electrode current collector layer can include Cu, Ni, Cr, Au, Pt, Ag, Al, Fe, Ti, Zn, Co, stainless steel, or a carbon sheet, but not limited to such a case. In particular, the material used in the negative electrode current collector layer may be one containing at least one selected from Cu, Ni and stainless steel or may be one made of a carbon sheet, for example, from the viewpoint of ensuring the reduction resistance and from the viewpoint of hardly alloying with lithium. The negative electrode current collector layer may have any coat layer on the surface thereof for the purpose of, for example, adjustment of the resistance.

The shape of the negative electrode current collector layer is not particularly limited, and examples can include a foil shape, a plate shape, or a mesh shape. In particular, a foil shape is preferred.

The thickness of the negative electrode current collector layer is not particularly limited, and may be 0.1 μm or more, or 1 μm or more, and may be 1 mm or less, or 100 μm or less.

### <Negative Electrode Active Material Layer>

In the lithium secondary battery of the present disclosure, the negative electrode active material layer contains a lithium metal or a lithium alloy.

In a case where the “negative electrode active material layer” contains a lithium metal, a layer of the lithium metal as the “negative electrode active material layer” is present in a charge state, whereas the lithium metal is moved as a lithium ion to the positive electrode active material layer and no layer of the lithium metal as the “negative electrode active material layer” may be present in a discharge state. Similarly, in a case where the “negative electrode active material layer” contains a lithium alloy, a layer of the lithium alloy as the “negative electrode active material layer” is present in a charge state, whereas lithium of the lithium alloy is moved as a lithium ion to the positive electrode active material layer and no layer of the lithium alloy as the “negative electrode active material layer” may be present and a layer of a metal due to removal of lithium from the lithium alloy may be present in a discharge state.

The negative electrode active material layer contains at least a lithium metal or a lithium alloy as a negative electrode active material, and may further optionally contain a conductive aid, a binder, a solid electrolyte, and the like. The negative electrode active material layer may contain various other additives. The content of each of the negative electrode active material, the conductive aid, the binder, the solid electrolyte, and the like in the negative electrode active material layer may be appropriately determined depending on the objective battery performance. For example, when the total (total solid content) of the negative electrode active material layer is assumed to be 100% by mass, the content of the negative electrode active material may be 40% by mass or more, 50% by mass or more, 60% by mass or more, and may be 100% by mass or less, or 90% by mass or less.

### (Negative Electrode Active Material)

The negative electrode active material here used is at least a lithium metal or a lithium alloy, as described above. The lithium alloy is not particularly limited, may be a material which is to be alloyed with lithium and can occlude and release a lithium ion, and examples include a silicon alloy-based negative electrode active material and a tin alloy-based active material, but not limited to these cases. The silicon alloy-based negative electrode active material is, for example, silicon, silicon oxide, silicon carbide, silicon nitride, or a solid solution thereof. The silicon alloy-based negative electrode active material can contain any other metal element than silicon, for example, Fe, Co, Sb, Bi, Pb, Ni, Cu, Zn, Ge, In, Sn, and/or Ti. The tin alloy-based negative electrode active material is, for example, tin, tin oxide, tin nitride, or a solid solution thereof. The tin alloy-based negative electrode active material can contain any other metal element than tin, for example, Fe, Co, Sb, Bi, Pb, Ni, Cu, Zn, Ge, In, Ti, and/or Si.

The negative electrode active material layer may contain any other negative electrode active material than the lithium metal or the lithium alloy. Such any other negative electrode active material than the lithium metal or the lithium alloy is not particularly limited, and examples include a carbon material. Examples of the carbon material include hard carbon, soft carbon, and graphite, but not limited to these cases.

The proportion of the lithium metal or the lithium alloy contained in the negative electrode active material layer is not particularly limited, and may be 50% by mass to 100% by mass, 60% by mass to 100% by mass, 70% by mass to 100% by mass, 80% by mass to 100% by mass, or 90% by mass to 100% by mass relative to the negative electrode active material layer.

### (Binder)

The binder is not particularly limited. The binder may be, for example, a material such as polyvinylidene fluoride (PVdF), butadiene rubber (BR), polytetrafluoroethylene (PTFE), or styrene-butadiene rubber (SBR), but not limited thereto. The binder is not particularly limited, and may be used singly or in combination of two or more kinds thereof.

### (Conductive Aid)

The conductive aid is not particularly limited. The conductive aid may be, for example, a vapor-grown carbon fiber (VGCF), acetylene black (AB), Ketjen black (KB), a carbon nanotube (CNT), or a carbon nanofiber (CNF), but not limited thereto. The conductive aid may be, for example, particulate or fibrous, and the size thereof is not particularly limited. The conductive aid is not particularly limited, and may be used singly or in combination of two or more kinds thereof.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an argyrodite-type solid electrolyte, but not limited thereto. Specific examples of the sulfide solid electrolyte can include Li₂S—P₂S₅—based solid electrolyte (Li₇P₃S₁₁, Li₃PS₄, Li₈P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, or the like), LiI—Li₂S—P₂O₅, LiI—Li₃PO₄—P₂S₅, or Li₇₋ₓPS₆₋ₓClₓ; or any combination thereof, but not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON), but not limited thereto.

The sulfide solid electrolyte and the oxide solid electrolyte may be each glass or crystallized glass (glass ceramics).

Examples of the polymer electrolyte include polyethylene oxide (PEO), polypropylene oxide (PPO), and any copolymer thereof, but not limited thereto.

The shape of the negative electrode active material is not particularly limited, and may be a shape common to negative electrode active materials for lithium secondary batteries. The negative electrode active material may have, for example, a layer shape or a sheet shape. The negative electrode active material may undergo deposition of lithium during charge, and/or may undergo dissolution of lithium during discharge. In this case, the negative electrode active material layer may be a layer composed of the lithium metal or the lithium alloy.

The shape of the negative electrode active material layer is not particularly limited, and may be, for example, a sheet-shaped negative electrode active material layer having a substantially flat surface. The thickness of the negative electrode active material layer is not particularly limited, and, for example, may be 0.1 μm or more, 1 μm or more, or 10 μm or more, and may be 2 mm or less, 1 mm or less, or 500 μm or less.

The negative electrode active material layer can be formed with reference to the description of “<<Method for producing lithium secondary battery>>” below.

### <Inorganic Porous Layer>

In the lithium secondary battery of the present disclosure, the inorganic porous layer contains a metal compound containing at least one metal element selected from calcium, barium, lanthanum, and cerium.

The metal compound may be selected from the group consisting of metal oxide, metal phosphate, metal sulfide, metal carbonate, metal alkoxide, metal hydroxide, and any combination thereof.

The inorganic porous layer is not particularly limited, and can be formed by an electrolytic reaction. The inorganic porous layer may contain a supporting salt contained in an electrolytic solution used in the electrolytic reaction, such as a lithium salt, and/or a decomposed product of a solvent.

The content of the metal element in the inorganic porous layer is not particularly limited, and may be 1% by mass or more, 5% by mass or more, 10% by mass or more, 20% by mass or more, 30% by mass or more, 40% by mass or more, 50% by mass or more, 60% by mass or more, or 70% by mass or more, and may be 95% by mass or less, 90% by mass or less, 80% by mass or less, 70% by mass or less, 60% by mass or less, or 50% by mass or less.

The thickness of the inorganic porous layer may be 10 nm to 100 μm. The thickness of the inorganic porous layer may be 10 nm or more, 20 nm or more, 30 nm or more, 40 nm or more, or 50 nm or more, and may be 500000 nm or less, 300000 nm or less, 200000 nm or less, or 100000 nm or less from the viewpoint of the capacity retention rate and the resistance value. The thickness of the inorganic porous layer can be measured by observation of a cross section of the inorganic porous layer with a scanning electron microscope (SEM).

The pore shape in the inorganic porous layer is not particularly limited. The porosity of the inorganic porous layer is not particularly limited, and may be 10% by volume or more, 20% by volume or more, 30% by volume or more, 40% by volume or more, or 50% by volume or more, and may be 90% by volume or less, 80% by volume or less, 70% by volume or less, 60% by volume or less, or 50% by volume or less. The porosity can be calculated from the following calculation formula with the apparent density and the true density of the inorganic porous layer

$$( Porosity ( \% by volume ) = \{ 1 - ( Apparent density ( g / {cm}^{3} ) / True density ( g / {cm}^{3} ) ) \} \times 100 ) .$$

The inorganic porous layer can be formed with reference to the description of “<<Method for producing lithium secondary battery>>” below.

### <Electrolyte Layer>

### <Electrolyte Layer-Solid Electrolyte Layer>

The lithium secondary battery of the present disclosure can be a solid-state battery, namely, and can have a solid electrolyte layer as the electrolyte layer.

The solid electrolyte layer may contain, if necessary, for example, a binder, in addition to the solid electrolyte.

The solid electrolyte and the binder can be determined with reference to the description of “<Negative electrode active material layer>”.

The thickness of the solid electrolyte layer is not particularly limited, and, for example, may be 0.1 μm or more, 1 μm or more, or 10 μm or more, and may be 2 mm or less, 1 mm or less, or 500 μm or less.

The solid electrolyte layer can be easily formed by, for example, dry or wet molding of an electrolyte mixture containing, for example, the above solid electrolyte and binder.

### <Electrolyte Layer-Separator Layer>

The lithium secondary battery of the present disclosure can be a liquid-based battery, namely, and can have an electrolytic solution as the electrolyte layer, in particular, an electrolytic solution retained in a separator layer.

### (Electrolytic Solution)

The electrolytic solution is not particularly limited, and preferably contains a supporting salt and a solvent.

The supporting salt (lithium salt) of an electrolytic solution having lithium ion conductivity is not particularly limited, and examples include an inorganic lithium salt and an organic lithium salt. Examples of the inorganic lithium salt include LiPF₆, LiBF₄, LiClO₄, or LiAsF₆, but not limited to these cases. Examples of the organic lithium salt include LiCF₃SO₃, LiN(CF₃SO₂)₂, LiN(C₂F₅SO₂)₂, LiN(FSO₂)₂, or LiC(CF₃SO₂)₃, but not limited to these cases.

The solvent used in the electrolytic solution is not particularly limited, and examples can include cyclic carbonate or linear carbonate. Examples of the cyclic carbonate can include ethylene carbonate (EC), propylene carbonate (PC), or butylene carbonate (BC), but not limited to such a case. Examples of the linear carbonate include dimethyl carbonate (DMC), diethyl carbonate (DEC), or ethyl methyl carbonate (EMC), but not limited to such a case. The electrolytic solution is not particularly limited, and may be used singly or in combination of two or more kinds thereof.

### (Separator)

The separator is not particularly limited, and a common separator for lithium secondary batteries can be appropriately selected. The separator here used can be, for example, a polyolefin-based, polyamide-based, or polyimide-based non-woven fabric.

### <Positive Electrode Active Material Layer>

The positive electrode active material layer contains at least a positive electrode active material, and may further optionally contain a conductive aid, a solid electrolyte, a binder, and the like. The positive electrode active material layer may contain various other additives. The content of each of the positive electrode active material, the conductive aid, the binder, and the like in the positive electrode active material layer may be appropriately determined depending on the objective battery performance. For example, when the total (total solid content) of the positive electrode active material layer is assumed to be 100% by mass, the content of the positive electrode active material may be 40% by mass or more, 50% by mass or more, 60% by mass or more, and may be 100% by mass or less, or 90% by mass or less.

### (Positive Electrode Active Material)

The material of the positive electrode active material is not particularly limited as long as it can occlude and release a lithium ion. The positive electrode active material may be, for example, lithium cobaltate (LiCoO₂), lithium nickelate (LiNiO₂), lithium manganate (LiMn₂O₄), lithium nickelate/cobaltate/manganate (NCM), LiCO_{1/3}Ni_{1/3}Mn_{1/3}O₂, lithium nickelate/cobaltate/aluminate (NCA; LiNiₓCo_{y}Al_{z}O₂), or Li—Mn spinel having a composition represented by Li₁₊ₓMn_{2-x-y}M_{y}O₄ (M is one or more metal elements selected from Al, Mg, Co, Fe, Ni, and Zn) by substitution with a dissimilar element, but not limited thereto.

The positive electrode active material is not particularly limited, and may have a covering layer. The covering layer is a layer containing a substance which has lithium ion conductive performance, which is low in reactivity with the positive electrode active material and the solid electrolyte, and which does not flow even if contacted with the active material or the solid electrolyte and then can allow the form of the covering layer to be kept. Specific examples of the material constituting the covering layer can include Li₄Ti₅O₁₂ or Li₃PO₄, in addition to LiNbO₃, but not limited thereto.

The shape of the positive electrode active material is not particularly limited as long as it is a shape common to positive electrode active materials for lithium secondary batteries. The positive electrode active material may be, for example, particulate. The positive electrode active material may be a primary particle, or may be a secondary particle of a plurality of primary particles aggregated. The average particle size D₅₀ of the positive electrode active material, for example, may be 1 nm or more, 5 nm or more, or 10 nm or more, and may be 500 μm or less, 100 μm or less, 50 μm or less, or 30 μm or less. The average particle size D₅₀ is here a particle size (median size) at which the cumulative value in a particle size distribution on a volume basis, determined by a laser diffraction/scattering method, is 50%.

The solid electrolyte, the binder, and the conductive aid can be determined with reference to the description of “<Negative electrode active material layer>”.

The shape of the positive electrode active material layer is not particularly limited, and may be, for example, a sheet-shaped positive electrode active material layer having a substantially flat surface. The thickness of the positive electrode active material layer is not particularly limited, and, for example, may be 0.1 μm or more, 1 μm or more, or 10 μm or more, and may be 2 mm or less, 1 mm or less, or 500 μm or less.

### <Positive Electrode Current Collector Layer>

The material used in the positive electrode current collector layer is not particularly limited, and a common positive electrode current collector for lithium secondary batteries can be appropriately selected. Examples of the material used in the positive electrode current collector layer can include Cu, Ni, Cr, Au, Pt, Ag, Al, Fe, Ti, Zn, Co, or stainless steel, but not limited to such a case. The positive electrode current collector layer may have any coat layer on the surface thereof for the purpose of, for example, adjustment of the resistance. The positive electrode current collector layer may be a metal foil or substrate on which the above metal is plated or vapor-deposited.

The shape of the positive electrode current collector layer is not particularly limited, and examples can include a foil shape, a plate shape, or a mesh shape. In particular, a foil shape is preferred.

The thickness of the positive electrode current collector layer is not particularly limited, and may be 0.1 μm or more, or 1 μm or more, and may be 1 mm or less, or 100 μm or less.

The positive electrode active material layer can be produced by applying a known method. For example, the positive electrode active material layer can be easily formed by dry or wet molding of a positive electrode mixture containing various components described above. The positive electrode active material layer may be formed together with the positive electrode current collector layer, or may be formed separately from the positive electrode current collector layer.

### <Shape and the Like of Lithium Secondary Battery>

Examples of the shape of the lithium secondary battery include a coin shape, a laminate shape (pouch battery), a cylindrical shape, or a square shape, but not limited to these cases.

FIG. 1 is a schematic view illustrating one aspect of the lithium secondary battery of the present disclosure, but not limited to such a case.

A lithium secondary battery 100 is a battery comprising a negative electrode current collector layer 111, a negative electrode active material layer 112, an inorganic porous layer 113, an electrolyte layer 120, a positive electrode active material layer 131, and a positive electrode current collector layer 132 in the listed order. The inorganic porous layer 113 disposed between the negative electrode active material layer 112 and the electrolyte layer 120 can allow the lithium secondary battery to be enhanced in capacity retention rate and reduced in resistance value. The inorganic porous layer 113 is a porous layer formed from an inorganic substance and therefore is presumed to be high in mechanical strength and electronic insulating properties and to be able to suppress decomposition of an electrolytic solution and breakage of a solid-electrolyte interface (Solid Electrolyte Interphase; SEI), resulting in an enhancement in capacity retention rate. An oxide of a metal element such as lanthanum is also known as an oxide solid electrolyte and is presumed to be high in lithium conductivity and to increase the lithium carrier concentration at an interface between the inorganic porous layer and the negative electrode active material layer, resulting in a reduction in battery resistance. Furthermore, it is presumed that a porous shape is adopted in the inorganic porous layer 113, thereby allowing the electrolytic solution to be promoted in diffusion into the inorganic porous layer and to easily reach the negative electrode active material, resulting in a reduction in battery resistance.

### <<Method for Producing Lithium Secondary Battery>>

The method for producing the lithium secondary battery of the present disclosure may comprise impregnating the negative electrode current collector layer with a solution containing the metal element and lithium, to form the negative electrode active material layer and the inorganic porous layer on a surface of the negative electrode current collector layer by an electrolytic reaction.

According to the method for producing the lithium secondary battery of the present disclosure, it is possible to produce a lithium secondary battery with a lithium metal and/or a lithium alloy as a negative electrode active material, in which the lithium secondary battery can be enhanced in capacity retention rate and reduced in resistance value.

### (Solution Used for Electrolytic Reaction)

The solution used for the electrolytic reaction in the method for producing the lithium secondary battery of the present disclosure is not particularly limited, and one may be used in which a compound containing lithium and a compound containing at least one metal element selected from calcium, barium, lanthanum, and cerium are dissolved in a solvent.

The solvent is not particularly limited, and examples can include cyclic carbonate or linear carbonate. Examples of the cyclic carbonate can include ethylene carbonate (EC), propylene carbonate (PC), or butylene carbonate (BC), but not limited to such a case. Examples of the linear carbonate include dimethyl carbonate (DMC), diethyl carbonate (DEC), or ethyl methyl carbonate (EMC), but not limited to such a case. The electrolytic solution is not particularly limited, and may be used singly or in combination of two or more kinds thereof.

The compound containing lithium is not particularly limited, and examples include LiCF₃SO₃, LiN(CF₃SO₂)₂, LiN(C₂F₅SO₂)₂, LiN(FSO₂)₂, or LiC(CF₃SO₂)₃, but not limited to these cases.

The compound containing at least one metal element selected from calcium, barium, lanthanum, and cerium is not particularly limited, and examples include Ca[N(CF₃SO₂)₂]₂, Ba[N(CF₃SO₂)₂]₂, La[N(CF₃SO₂)₂]₃, or Ce[N(CF₃SO₂)₂]₃, but not limited to these cases.

### (Electrolytic Reaction)

The electrolytic reaction is not particularly limited, and can be conducted by cyclic voltammetry with a negative electrode current collector as a working electrode. Cyclic voltammetry conditions include, for example, a potential of 0 to 0.3 V and a scanning speed of 1 mV/s, and the thickness of the inorganic porous layer may be adjusted by the number of cycles.

The compound containing at least one metal element selected from calcium, barium, lanthanum, and cerium contained in the solvent is not particularly limited, and may form metal oxide, metal phosphate, metal sulfide, metal carbonate, metal alkoxide, metal hydroxide, or the like by the electrolytic reaction.

FIG. 2 is a schematic view illustrating one aspect of the method for producing the lithium secondary battery of the present disclosure, but not limited to such a case. The method for producing the lithium secondary battery is described with FIG. 1 and FIG. 2.

First, a negative electrode current collector layer 111 illustrated in FIG. 2A is impregnated with a solution containing lithium and at least one metal element selected from calcium, barium, lanthanum, and cerium, and the electrolytic reaction is conducted. The electrolytic reaction can be conducted by, for example, cyclic voltammetry. In the negative electrode current collector layer 111 after the electrolytic reaction, a negative electrode active material layer 112 and an inorganic porous layer 113 are formed on the surface of the negative electrode current collector layer 111 in the listed order, as illustrated in FIG. 2B, and a negative electrode laminate 110 in which the negative electrode current collector layer 111, the negative electrode active material layer 112, and the inorganic porous layer 113 are stacked in the listed order can be obtained. Next, a positive electrode active material layer 131 is formed by wet or dry application of a positive electrode mixture onto a positive electrode current collector layer 132, and thus a positive electrode laminate 130 illustrated in FIG. 2C can be formed. Thereafter, a negative electrode laminate 110, an electrolyte layer 120, and a positive electrode laminate 130 are stacked, and thus a lithium secondary battery 100 illustrated in FIG. 1, comprising the negative electrode current collector layer 111, the negative electrode active material layer 112, the inorganic porous layer 113, the electrolyte layer 120, the positive electrode active material layer 131, and the positive electrode current collector layer 132 in the listed order, can be formed.

### EXAMPLES

The present disclosure is described in further detail with reference to Examples shown below, but the scope of the present disclosure is not limited to these Examples.

### Example 1

### <Production of Negative Electrode Laminate: Formation of Negative Electrode Active Material Layer and Inorganic Porous Layer on Negative Electrode Current Collector Layer>

Copper (Cu) foil serving as a negative electrode current collector and a lithium metal were stacked so as to be opposite with a polyolefin film (film thickness 20 μm) as a separator being interposed therebetween, and were accommodated in a cell container. Next, an electrolytic solution constituted from bis(trifluoromethanesulfonyl)imide lithium (LiTFSI), bis(trifluoromethanesulfonyl)imide calcium (Ca(TFSI)₂), ethylene carbonate (EC), and propylene carbonate (PC) was injected to the container, and the cell container was sealed. The Cu foil was used as a working electrode and the lithium metal was used as a counter electrode, and cyclic voltammetry (potential: 0 to 0.3 V, scanning speed: 1 mV/s, end voltage: 0 V) was carried out for 20 cycles in the cell container. A lithium metal layer and an inorganic porous layer were formed on the Cu foil in the course of cyclic voltammetry. Thereafter, the cell container was disassembled, the Cu foil on which the lithium metal layer and the inorganic porous layer were formed was recovered, and adopted as a negative electrode laminate. The negative electrode laminate comprised a negative electrode current collector layer, a negative electrode active material layer, and the inorganic porous layer in the listed order, and the inorganic porous layer had a thickness of 50 nm.

### <Production of Positive Electrode Laminate>

A positive electrode mixture slurry was prepared by mixing LiNi_{1/3}Co_{1/3}Mn_{1/3}O₂ (84 parts by mass) as a positive electrode active material, acetylene black (12 parts by mass) as a conductive aid, PVdF (4 parts by mass) as a binder, and a moderate amount of N-methyl-2-pyrrolidone (NMP) as a dispersion medium. Next, the resulting positive electrode mixture slurry was applied onto aluminum (Al) foil as a positive electrode current collector, and dried, thereby producing a positive electrode laminate in which a positive electrode active material layer was formed on the Al foil.

### <Production of Lithium Secondary Battery>

The negative electrode laminate and the positive electrode laminate were stacked so as to be opposite with a polyolefin film (film thickness 20 μm) as a separator being interposed therebetween, and wound in a spiral manner. Respective terminals were connected to the negative electrode laminate and the positive electrode laminate wound, and were received in a battery case, 1 M LiPF₆ EC/dimethyl carbonate (DMC) (1/1(volume ratio)) as an electrolytic solution was injected thereinto, and the battery case was sealed, to produce a lithium secondary battery.

### <Evaluation of Capacity Retention Rate of Lithium Secondary Battery>

The lithium secondary battery was charged and discharged for 200 cycles with a constant-current (current rate 1 C) system in a cut-off voltage range of 3.3 to 4.2 V at 25° C. The capacity was measured at the first cycle and the 200-th cycle, and the capacity retention rate (Capacity retention rate=(Capacity at 200-th cycle)/(Capacity at first cycle)×100) of the lithium secondary battery was calculated. Table 1 shows the results of the capacity retention rate. The capacity retention rate in Table 1 is a relative value in a case where the capacity retention rate of the lithium secondary battery in Comparative Example 1 is 1.00.

### <Evaluation of Resistance Value of Lithium Secondary Battery>

The lithium secondary battery was adjusted so that the open voltage was 3.70 V. Next, the lithium secondary battery was discharged at −10° C. and a current rate of 5 C for 8 seconds, to measure the voltage drop (AV), and the resistance value (current value at a resistance value of AV/5 C) of the lithium secondary battery was calculated. Table 1 shows the results of the resistance value. The resistance value in Table 1 is a relative value in a case where the resistance value of the lithium secondary battery in Comparative Example 1 is 1.00.

### Comparative Example 1

### <Production of Negative Electrode Laminate: Formation of Negative Electrode Active Material Layer and Inorganic Porous Layer on Negative Electrode Current Collector Layer>

A negative electrode laminate was produced by the same method as in Example 1 except that an electrolytic solution constituted from LiTFSI, EC, and PC, namely, an electrolytic solution in which Ca(TFSI)₂ was removed from the electrolytic solution in Example 1 was used.

### <Production of Lithium Secondary Battery, Evaluation of Capacity Retention Rate Thereof, and Evaluation of Resistance Value Thereof>

A lithium secondary battery was produced with the negative electrode laminate produced in Comparative Example 1, by the same method as in Example 1. The capacity retention rate and the resistance value of the lithium secondary battery were evaluated by the same methods as in Example 1. Examples and Comparative Examples herein show each relative value in a case where the capacity retention rate and the resistance value of the lithium secondary battery in Comparative Example 1 are each 1.00.

### Examples 2 to 4 (Metal Element Constituting Inorganic Porous Layer)

### <Production of Negative Electrode Laminate: Formation of Negative Electrode Active Material Layer and Inorganic Porous Layer on Negative Electrode Current Collector Layer>

Each negative electrode laminate was produced by the same method as in Example 1 except that Ba(TFSI)₂, Ce(TFSI)₃, or La(TFSI)₃ was used instead of Ca(TFSI)₂.

### <Production of Lithium Secondary Battery, Evaluation of Capacity Retention Rate of Such Battery, and Evaluation of Resistance Value of Such Battery>

A lithium secondary battery was produced with each of the negative electrode laminates produced in Examples 2 to 4, by the same method as in Example 1. The capacity retention rate and the resistance value of the lithium secondary battery in each of Examples 2 to 4 were evaluated by the same methods as in Example 1. The respective results were as shown in Table 1.

TABLE 1

| | | | Evaluation results | |
|---|---|---|---|---|
| | Negative electrode laminate | | Capacity retention | Resistance value |
| | Metal element | Thickness of | rate relative to | relative to |
| | contained in | inorganic | Comparative | Comparative |
| | inorganic | porous layer | Example 1 | Example 1 |
| | porous layer | [nm] | [—] | [—] |
| Comparative | — | 50 | 1.00 | 1.00 |
| Example 1 | | | | |
| Example 1 | Calcium (Ca) | 50 | 1.32 | 0.83 |
| Example 2 | Barium (Ba) | 50 | 1.33 | 0.88 |
| Example 3 | Cerium (Ce) | 50 | 1.43 | 0.85 |
| Example 4 | Lanthanum (La) | 50 | 1.41 | 0.84 |

It could be confirmed that the lithium secondary battery comprising the inorganic porous layer into which the metal element was introduced (Examples 1 to 4) was increased in capacity retention rate and decreased in resistance value as compared with the lithium secondary battery comprising the inorganic porous layer containing no metal element (Comparative Example 1).

The inorganic porous layer is a porous layer formed from an inorganic substance and therefore is presumed to be high in mechanical strength and electronic insulating properties and to be able to suppress decomposition of the electrolytic solution and breakage of SEI, thereby leading to an enhancement in capacity retention rate. In addition, an oxide of lanthanum or the like is known as an oxide solid electrolyte and is presumed to be high in lithium conductivity and to increase the lithium carrier concentration at an interface between the inorganic porous layer and the negative electrode active material layer, resulting in a reduction in resistance value. Furthermore, it is presumed that a porous form is adopted, thereby allowing the electrolytic solution to be promoted in diffusion into the inorganic porous layer and to easily reach the negative electrode active material, resulting in a reduction in resistance value.

### Examples 5 to 11 (Thickness of Inorganic Porous Layer)

<Production of Negative Electrode Laminate: Formation of Negative Electrode Active Material Layer and Inorganic Porous Layer on Negative Electrode Current Collector Layer>

Each negative electrode laminate was produced by the same method as in Example 4, except that the number of cycles in cyclic voltammetry was adjusted, and thus, the thickness of the inorganic porous layer was as described in Table 2 in Example 4.

### <Production of Lithium Secondary Battery, Evaluation of Capacity Retention Rate Thereof, and Evaluation of Resistance Value Thereof>

A lithium secondary battery was produced with the negative electrode laminate produced in each of Examples 5 to 11, by the same method as in Example 1. The capacity retention rate and the resistance value of the lithium secondary battery in each of Examples 5 to 11 were evaluated by the same methods as in Example 1. The respective results were as shown in Table 2.

### Comparative Example 2 (Thickness of Inorganic Porous Layer)

### <Production of Negative Electrode Laminate: Formation of Negative Electrode Active Material Layer and Inorganic Porous Layer on Negative Electrode Current Collector Layer>

A negative electrode laminate was produced by the same method as in Comparative Example 1, except that the number of cycles in cyclic voltammetry was adjusted, and thus, the thickness of the inorganic porous layer was as described in Table 2 in Comparative Example 1.

### <Production of Lithium Secondary Battery, Evaluation of Capacity Retention Rate Thereof, and Evaluation of Resistance Value Thereof>

A lithium secondary battery was produced with the negative electrode laminate produced in Comparative Example 2, by the same method as in Example 1. The capacity retention rate and the resistance value of the lithium secondary battery in Comparative Example 2 were evaluated by the same methods as in Example 1. The respective results were as shown in Table 2.

TABLE 2

| | | | Evaluation results | |
|---|---|---|---|---|
| | Negative electrode laminate | | Capacity retention | Resistance value |
| | Metal element | Thickness of | rate relative to | relative to |
| | contained in | inorganic | Comparative | Comparative |
| | inorganic | porous layer | Example 1 | Example 1 |
| | porous layer | [nm] | [—] | [—] |
| Comparative | — | 50 | 1.00 | 1.00 |
| Example 1 | | | | |
| Comparative | — | 1000 | 0.74 | 2.22 |
| Example 2 | | | | |
| Example 4 | Lanthanum (La) | 50 | 1.41 | 0.84 |
| Example 5 | Lanthanum (La) | 100 | 1.89 | 0.64 |
| Example 6 | Lanthanum (La) | 300 | 1.88 | 0.63 |
| Example 7 | Lanthanum (La) | 600 | 1.99 | 0.59 |
| Example 8 | Lanthanum (La) | 1000 | 2.01 | 0.58 |
| Example 9 | Lanthanum (La) | 10000 | 1.87 | 0.62 |
| Example 10 | Lanthanum (La) | 100000 | 1.84 | 0.61 |
| Example 11 | Lanthanum (La) | 150000 | 1.51 | 0.88 |

The lithium secondary battery comprising the inorganic porous layer containing no metal element (Comparative Examples 1 and 2) was decreased in capacity retention rate and increased in resistance value in a case where the thickness of the inorganic porous layer was increased from 50 nm to 1000 nm. The lithium secondary battery comprising the inorganic porous layer containing no metal element was highly increased in resistance value in a case where the thickness of the inorganic porous layer was 1000 nm, and it was thus presumed that the inorganic porous layer served as a resistance layer to result in a decrease in capacity retention rate. On the other hand, the lithium secondary battery comprising the inorganic porous layer containing lanthanum as the metal element was increased in capacity retention rate and decreased in resistance value even in a case where the thickness was large as compared with a thickness of 50 nm, and exhibited the most favorable capacity retention rate and resistance value at a thickness of 1000 nm.

Although preferred embodiments of the lithium secondary battery and the method for producing the lithium secondary battery of the present disclosure are described, it is understood by those skilled in the art that modifications can be made without departing from the claims.

### REFERENCE SIGNS LIST

100 Lithium secondary battery
110 Negative electrode laminate
111 Negative electrode current collector layer
112 Negative electrode active material layer
113 Inorganic porous layer
120 Electrolyte layer
130 Positive electrode laminate
131 Positive electrode active material layer
132 Positive electrode current collector layer

1. A lithium secondary battery, wherein
the lithium secondary battery comprises a negative electrode current collector layer, a negative electrode active material layer, an inorganic porous layer, an electrolyte layer, a positive electrode active material layer, and a positive electrode current collector layer in the listed order,
the negative electrode active material layer contains a lithium metal or a lithium alloy, and
the inorganic porous layer contains a metal compound containing at least one metal element selected from calcium, barium, lanthanum, and cerium.

2. The lithium secondary battery according to claim 1, wherein the thickness of the inorganic porous layer is 10 nm to 100 μm.

3. The lithium secondary battery according to claim 1, wherein the metal compound is selected from the group consisting of metal oxide, metal phosphate, metal sulfide, metal carbonate, metal alkoxide, metal hydroxide, and any combination thereof.

4. A method for producing the lithium secondary battery according to claim 1, the method comprising impregnating the negative electrode current collector layer with a solution containing the metal element and lithium, to form the negative electrode active material layer and the inorganic porous layer on a surface of the negative electrode current collector layer by an electrolytic reaction.
